(19) United States
(12) Patent Application Publication
(10) Pub. No.: US 2025/0274964 A1
(43) Pub. Date: Aug. 28, 2025

(54) WIFI DATA TRANSMISSION METHOD AND APPARATUS, ELECTRONIC DEVICE, RADIO ACCESS DEVICE, AND READABLE STORAGE MEDIUM

(71) Applicant: VIVO MOBILE COMMUNICATION CO., LTD., Dongguan (CN)

(72) Inventor: Yonghui LAN, Dongguan (CN)

(73) Assignee: VIVO MOBILE COMMUNICATION CO., LTD., Dongguan (CN)

(21) Appl. No.: 19/205,923

(22) Filed: May 12, 2025

Related U.S. Application Data
(63) Continuation of application No. PCT/CN2023/127301, filed on Oct. 27, 2023.

(30) Foreign Application Priority Data
Nov. 11, 2022 (CN) 202211413823.8

(51) Int. Cl. H04W 72/53; H04W 72/0453; H04W 84/12

(52) U.S. Cl. CPC H04W 72/53; H04W 72/0453; H04W 84/12

(57) ABSTRACT

A WiFi data transmission method and apparatus are provided. The method includes: sending, by a radio access device, a WiFi broadcast packet, where the WiFi broadcast packet includes channel information of a first channel; receiving, by the radio access device through the first channel, a probe request frame sent by an electronic device; when the probe request frame indicates that the electronic device supports a simultaneous transmission and reception function, determining, by the radio access device, a target WiFi data transmit channel and a target WiFi data receive channel based on a first channel frequency of the first channel; and performing, by the radio access device, data transmission with the electronic device through the target WiFi data transmit channel and the target WiFi data receive channel, where the target WiFi data transmit channel and the target WiFi data receive channel are different channels in a same WiFi band.

### CROSS-REFERENCE TO RELATED APPLICATIONS

This application is a continuation of International Application No. PCT/CN2023/127301, filed Oct. 27, 2023, which claims priority to Chinese Patent Application No. 202211413823.8, filed Nov. 11, 2022. The entire contents of each of the above-referenced applications are expressly incorporated herein by reference.

### TECHNICAL FIELD

This application pertains to the field of communication technologies, and specifically relates to a WiFi data transmission method and apparatus, an electronic device, a radio access device, and a readable storage medium.

### BACKGROUND

With the technological development of electronic devices, functions of the electronic devices are increasingly rich. For example, an electronic device may transmit WiFi data by using a Wireless Fidelity (WiFi) network. Specifically, the electronic device may transmit WiFi data in a Time Division Multiplexing (TDM) manner, that is, the electronic device alternately sends or receives WiFi data within time periods of a same length. Consequently, a WiFi data transmission rate is relatively low.

### SUMMARY

Embodiments of this application provide a WiFi data transmission method and apparatus, an electronic device, a radio access device, and a readable storage medium.

According to a first aspect, an embodiment of this application provides a WiFi data transmission method. The method includes: sending, by a radio access device, a WiFi broadcast packet, where the WiFi broadcast packet includes channel information of a first channel; receiving, by the radio access device through the first channel, a probe request frame sent by an electronic device; in a case that the probe request frame indicates that the electronic device supports a simultaneous transmission and reception function, determining, by the radio access device, a target WiFi data transmit channel and a target WiFi data receive channel based on a first channel frequency of the first channel; and performing, by the radio access device, data transmission with the electronic device through the target WiFi data transmit channel and the target WiFi data receive channel, where the target WiFi data transmit channel and the target WiFi data receive channel are different channels in a same WiFi band.

According to a second aspect, an embodiment of this application further provides a WiFi data transmission method. The method includes: receiving, by an electronic device, a WiFi broadcast packet broadcast by a radio access device, where the WiFi broadcast packet includes channel information of a first channel; sending, by the electronic device, a probe request frame to the radio access device through the first channel, where the probe request frame is used to indicate that the electronic device supports a simultaneous transmission and reception function; and receiving, by the electronic device through the first channel, a probe response frame sent by the radio access device, where the probe response frame is used to instruct the electronic device to perform data transmission with the radio access device through a target WiFi data transmit channel and a target WiFi data receive channel, where the target WiFi data transmit channel and the target WiFi data receive channel are different channels in a same WiFi band.

According to a third aspect, an embodiment of this application provides a WiFi data transmission apparatus. The apparatus includes a sending module, a receiving module, a determining module, and a transmission module. The sending module is configured to send a WiFi broadcast packet, where the WiFi broadcast packet includes channel information of a first channel. The receiving module is configured to receive, through the first channel, a probe request frame sent by an electronic device. The determining module is configured to: in a case that the probe request frame indicates that the electronic device supports a simultaneous transmission and reception function, determine a target WiFi data transmit channel and a target WiFi data receive channel based on a first channel frequency of the first channel. The transmission module is configured to perform data transmission with the electronic device through the target WiFi data transmit channel and the target WiFi data receive channel, where the target WiFi data transmit channel and the target WiFi data receive channel are different channels in a same WiFi band.

According to a fourth aspect, an embodiment of this application further provides a WiFi data transmission apparatus. The apparatus includes a receiving module, a sending module, and a switching module. The receiving module is configured to receive a WiFi broadcast packet sent by a radio access device, where the WiFi broadcast packet includes channel information of a first channel. The sending module is configured to send a probe request frame to the radio access device through the first channel, where the probe request frame is used to indicate that the electronic device supports a simultaneous transmission and reception function. The receiving module is configured to receive, through the first channel, a probe response frame sent by the radio access device, where the probe response frame is used to instruct the electronic device to perform data transmission with the radio access device through a target WiFi data transmit channel and a target WiFi data receive channel, where the target WiFi data transmit channel and the target WiFi data receive channel are different channels in a same WiFi band.

According to a fifth aspect, an embodiment of this application provides a radio access device. The radio access device includes a processor and a memory, the memory stores a program or an instruction that can be run on the processor, and the program or the instruction is executed by the processor to implement the steps of the method according to the first aspect.

According to a sixth aspect, an embodiment of this application provides a radio access device, including a processor and a communication interface. The communication interface is configured to: send a WiFi broadcast packet, and receive, through a first channel, a probe request frame sent by an electronic device. The processor is configured to determine a target WiFi data transmit channel and a target WiFi data receive channel of the electronic device based on a first channel frequency of the first channel. The communication interface is further configured to send a probe response frame to the electronic device through the first channel, where the probe response frame is used to instruct the electronic device to perform data transmission with the radio access device through the target WiFi data transmit channel and the target WiFi data receive channel.

According to a seventh aspect, an embodiment of this application provides an electronic device. The electronic device includes a processor and a memory, the memory stores a program or an instruction that can be run on the processor, and the program or the instruction is executed by the processor to implement the steps of the method according to the second aspect.

According to an eighth aspect, an embodiment of this application provides an electronic device, including a processor and a communication interface. The communication interface is configured to receive a WiFi broadcast packet sent by a target radio access device; send a probe request frame to the radio access device through a first channel; and receive, through the first channel, a probe response frame sent by the radio access device. The processor is configured to switch to a target WiFi data transmit channel and a target WiFi data receive channel based on channel switching announcement information.

According to a ninth aspect, an embodiment of this application provides a readable storage medium. The readable storage medium stores a program or an instruction, and the program or the instruction is executed by a processor to implement the steps of the method according to the first aspect or the second aspect.

According to a tenth aspect, an embodiment of this application provides a chip. The chip includes a processor and a communication interface, the communication interface is coupled to the processor, and the processor is configured to run a program or an instruction to implement the method according to the first aspect or the second aspect.

According to an eleventh aspect, an embodiment of this application provides a computer program product. The program product is stored in a storage medium, and the program product is executed by at least one processor to implement the method according to the first aspect or the second aspect.

According to a twelfth aspect, an embodiment of this application provides a communication system, including a radio access device and an electronic device. The radio access device may be configured to execute the steps of the WiFi data transmission method according to the first aspect, and the electronic device may be configured to execute the steps of the WiFi data transmission method according to the second aspect.

In the embodiments of this application, the radio access device sends the WiFi broadcast packet, where the WiFi broadcast packet includes the channel information of the first channel; the radio access device receives, through the first channel, the probe request frame sent by the electronic device; in a case that the probe request frame indicates that the electronic device supports the simultaneous transmission and reception function, the radio access device determines the target WiFi data transmit channel and the target WiFi data receive channel based on the first channel frequency of the first channel; and the radio access device and the electronic device perform data transmission through the target WiFi data transmit channel and the target WiFi data receive channel, where the target WiFi data transmit channel and the target WiFi data receive channel are different channels in a same WiFi band. In this solution, the radio access device may configure a WiFi data receive channel and a WiFi data transmit channel for the electronic device based on a channel frequency of a channel (that is, the first channel) used by the electronic device to send the probe request frame, so that the electronic device can simultaneously receive and send WiFi data, thereby improving a WiFi data transmission rate.

### BRIEF DESCRIPTION OF DRAWINGS

FIG. 1 is a block diagram of a wireless communication system according to an embodiment of this application;

FIG. 2 is a first flowchart of a WiFi data transmission method according to an embodiment of this application;

FIG. 3 is a first schematic example diagram of a WiFi data transmission method according to an embodiment of this application;

FIG. 4 is a second schematic example diagram of a WiFi data transmission method according to an embodiment of this application;

FIG. 5 is a second flowchart of a WiFi data transmission method according to an embodiment of this application;

FIG. 6 is a third flowchart of a WiFi data transmission method according to an embodiment of this application;

FIG. 7 is a first schematic structural diagram of hardware of an electronic device according to an embodiment of this application;

FIG. 8 is a first schematic structural diagram of a WiFi data transmission apparatus according to an embodiment of this application;

FIG. 9 is a second schematic structural diagram of a WiFi data transmission apparatus according to an embodiment of this application;

FIG. 10 is a schematic structural diagram of hardware of a communication device according to an embodiment of this application;

FIG. 11 is a second schematic structural diagram of hardware of an electronic device according to an embodiment of this application; and

FIG. 12 is a schematic structural diagram of hardware of a radio access device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th generation (6G) communication system.

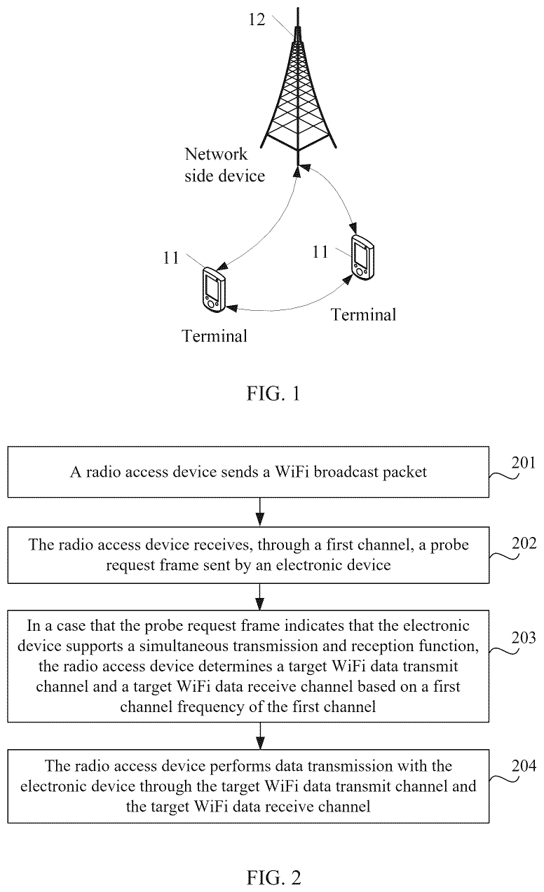

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a WLAN access point, a radio access device, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. As long as a same technical effect is achieved, the base station is not limited to a specified technical term. It should be noted that, in this application, only a base station in an NR system is used as an example, and a specific type of the base station is not limited.

The following describes some terms/nouns used in the embodiments of this application.

### 1. Time Division Multiplexing (TDM)

In TDM, a period of time is divided into time division multiplexing frames (TDM frame) with a same length. Each electronic device of time division multiplexing occupies slots with a fixed number in each TDM frame, and the slots occupied by each electronic device appear periodically (whose period is a time length of the TDM frame). All electronic devices of time division multiplexing occupy the TDM frame within different time periods.

### 2. Frequency Division Multiplexing (FDM)

In FDM, after a specific band is allocated to an electronic device, the electronic device occupies the band from beginning to end in a communication process. It can be learned that all electronic devices of frequency division multiplexing occupy different bandwidth resources within a same time period.

With reference to the accompanying drawings, the following describes in detail a WiFi data transmission method and apparatus, an electronic device, a radio access device, and a readable storage medium provided in the embodiments of this application by using specific embodiments and application scenarios thereof.

Currently, an electronic device transmits WiFi data in a TDM manner, and consequently a WiFi data transmission rate is relatively low.

To resolve this problem, in the related technology, for an electronic device that supports a dual-antenna (mimo) mode, the electronic device may switch to a single-antenna (siso) mode and simultaneously receive and send WiFi data in a Dual Band Simultaneous (DBS) manner, so as to improve a WiFi data transmission rate. However, switching from the mimo mode to the siso mode results in halving of WiFi performance (for example, a delay and a packet loss rate) of the electronic device. That is, in the related technology, the WiFi data transmission rate is increased at the expense of the WiFi performance of the electronic device.

In the WiFi data transmission method provided in this application, a radio access device may declare, in a WiFi broadcast phase, that an electronic device separately receives and sends WiFi data through different channels, that is, separation between a WiFi data receive channel and a WiFi data transmit channel is implemented. In this way, WiFi data can be simultaneously received and sent without sacrificing WiFi performance, so as to improve a WiFi data transmission rate.

In some embodiments, the radio access device may send a WiFi broadcast packet. The WiFi broadcast packet includes channel information of a first channel. After receiving the WiFi broadcast packet, the electronic device may send a probe request frame to the radio access device through the first channel. The radio access device may receive the probe request frame through the first channel, determine a target WiFi data transmit channel and a target WiFi data receive channel of the electronic device based on a first channel frequency of the first channel, and send a probe response frame to the electronic device through the first channel, where the probe response frame is used to instruct the electronic device to perform data transmission with the radio access device through the target WiFi data transmit channel and the target WiFi data receive channel. The target WiFi data transmit channel and the target WiFi data receive channel are different channels in a same WiFi band. In this way, according to the WiFi data transmission method provided in the embodiments of this application, WiFi data is simultaneously received and sent in a manner of separating a transmit channel from a receive channel. Therefore, a WiFi data transmission rate can be improved, and degrading of WiFi performance of the electronic device can be avoided.

An embodiment of this application provides a WiFi data transmission method. FIG. 2 is a flowchart of a WiFi data transmission method according to an embodiment of this application. The method may be applied to a radio access device. As shown in FIG. 2, the WiFi data transmission method provided in this embodiment of this application may include the following step 201 to step 204.

Step 201: A radio access device sends a WiFi broadcast packet.

The WiFi broadcast packet includes channel information of a first channel, and the first channel is a channel in a target WiFi band.

In this embodiment of this application, an electronic device may receive the WiFi broadcast packet sent by the radio access device.

In some embodiments, the first channel may be a channel currently used by the radio access device or a channel on which the radio access device is located.

In some embodiments, the WiFi broadcast packet includes content such as a beacon frame and an address field, where the beacon frame includes information about the first channel (that is, a channel on which current WiFi is located).

In some embodiments, the target WiFi band may be 2.4G, 5G, or 6G. 2.4G is divided into 14 channels (1 to 14), and is a band of 2412 MHz to 2484 MHz. 5G has 60 channels (32 to 173) in total, and is a band of 5160 MHz to 5865 MHz. 6G has 233 channels (1 to 233), and is a band of 5946 MHz to 7105 MHz.

Step 202: The radio access device receives, through the first channel, a probe request frame sent by the electronic device.

The probe request frame includes an identifier of the electronic device, and the probe request frame may be used to detect a radio access device in an area in which the electronic device is located.

In some embodiments, the identifier of the electronic device may include information such as a vendor unique identifier and a device name.

Step 203: In a case that the probe request frame indicates that the electronic device supports a simultaneous transmission and reception function, the radio access device determines a target WiFi data transmit channel and a target WiFi data receive channel based on a first channel frequency of the first channel.

The target WiFi data transmit channel and the target WiFi data receive channel may be different channels in a same WiFi band.

In this embodiment of this application, the first channel frequency may be a center frequency of the first channel.

In some embodiments, after receiving the probe request frame, the radio access device may determine, based on the identifier included in the probe request frame, whether the electronic device supports the simultaneous transmission and reception function. In a case that the electronic device supports the simultaneous transmission and reception function, the radio access device may determine the target WiFi data transmit channel and the target WiFi data receive channel of the electronic device based on the first channel frequency of the first channel. In some embodiments, in a case that the electronic device does not support the simultaneous transmission and reception function, the radio access device may directly send a probe response frame to the electronic device, where the probe response frame is the same as the probe response frame in the related technology.

Step 204: The radio access device performs data transmission with the electronic device through the target WiFi data transmit channel and the target WiFi data receive channel.

The target WiFi data transmit channel and the target WiFi data receive channel are different channels in a same WiFi band.

In some embodiments, the radio access device may send the probe response frame to the electronic device on the first channel. The electronic device may receive the probe response frame on the first channel.

In some embodiments, the probe response frame may be used to instruct the electronic device to perform data transmission with the radio access device through the target WiFi data transmit channel and the target WiFi data receive channel.

In some embodiments, the electronic device switches to the target WiFi data transmit channel and the target WiFi data receive channel based on channel switching announcement information.

In the WiFi data transmission method provided in this embodiment of this application, the radio access device may configure the target WiFi data receive channel and the target WiFi data transmit channel for the electronic device based on a channel frequency of a channel (that is, the first channel) used by the electronic device to send the probe request frame, so that the electronic device can simultaneously receive and send WiFi data, thereby improving a WiFi data transmission rate.

In this way, the radio access device can select the target WiFi data transmit channel and the target WiFi data receive channel for the electronic device only when it is determined that the electronic device supports the simultaneous transmission and reception function, thereby saving power consumption of the radio access device.

In some embodiments, the foregoing step 203 may be implemented by the following step 203a and step 203b.

Step 203a: In a case that the probe request frame indicates that the electronic device supports the simultaneous transmission and reception function, the radio access device determines a target channel allocation policy based on the first channel frequency of the first channel.

Step 203b: The radio access device determines the target WiFi data transmit channel and the target WiFi data receive channel based on the target channel allocation policy.

In some embodiments, methods for determining the target channel allocation policy by the radio access device may be different for different target WiFi bands.

In some embodiments, when the target WiFi band is a 2.4G band, the radio access device may determine the target channel allocation policy in the following possible implementation. When the target WiFi band is a 5G band or a 6G band, the radio access device may determine the target channel allocation policy in the following another possible implementation.

The following separately describes one possible implementation and another possible implementation in detail.

### One Possible Implementation

In some embodiments, the foregoing step 203a may be implemented by the following step A to step C.

Step A: In a case that the first channel frequency of the first channel is equal to a first frequency, the radio access device determines that the target channel allocation policy is a first policy.

Step B: In a case that the first channel frequency of the first channel is less than the first frequency, the radio access device determines that the target channel allocation policy is a second policy.

Step C: In a case that the first channel frequency of the first channel is greater

than the first frequency, the radio access device determines that the target channel allocation policy is a third policy.

The first frequency is a frequency corresponding to a target WiFi band, and the target WiFi band is a band corresponding to the first channel.

In some embodiments, the first frequency may be a frequency of a channel (for example, a channel 7) in the 2.4G band (that is, the target WiFi band).

Further, in some embodiments, the first frequency may be a center frequency of a channel in the 2.4G band, for example, the first frequency may be 2442 MHz (that is, a center frequency of the channel 7).

In actual implementation, the first frequency may be any possible frequency of a channel in the 2.4G band, and may be determined based on an actual use requirement.

The following exemplarily describes the first policy, the second policy, and the third policy in three manners.

In some embodiments, in manner 1, it is assumed that the target WiFi band may include a receive channel set and a transmit channel set, and each channel set includes a plurality of channels.

The first policy may include: determining the first channel as the target WiFi data transmit channel, and determining a second channel as the target WiFi data receive channel, where the second channel is an available channel that is in the receive channel set and whose difference from the first channel frequency of the first channel is the largest.

The second policy may include: determining the first channel as the target WiFi data transmit channel, and determining a third channel as the target WiFi data receive channel, where the third channel is a channel that is in the receive channel set and whose difference from the first channel frequency of the first channel is equal to a first preset frequency.

The third policy includes: determining a fourth channel as the target WiFi data transmit channel, and determining the first channel as the target WiFi data receive channel, where the fourth channel is a channel that is in the transmit channel set and whose difference from the first channel frequency of the first channel is equal to the first preset frequency.

The first preset frequency is greater than a frequency interval between two adjacent channels in the target WiFi band.

For example, assuming that the frequency interval between the two adjacent channels in the target WiFi band is f₀, the first preset frequency may be N*f₀, where N is a positive integer greater than 1. Further, f₀ may be 5 MHz.

It should be noted that in manner 1, the radio access device may pre-classify channels in the target WiFi band into the receive channel set and the transmit channel set, and channels in each receive channel set are consecutive. A maximum channel frequency corresponding to the receive channel set may be less than a minimum channel frequency corresponding to the transmit channel set. In some embodiments, a minimum channel frequency corresponding to the receive channel set may be greater than a maximum channel frequency corresponding to the transmit channel set.

In some embodiments, the radio access device may classify a channel 1 to a channel 7 in 2.4G into the transmit channel set, and classify a channel 8 to a channel 14 into the receive channel set (1); or the radio access device may classify a channel 1 to a channel 7 in 2.4G into the receive channel set, and classify a channel 8 to a channel 14 into the transmit channel set (2). It may be understood that the channel 1 to channel 14 in the 2.4G band are numbered in a sequence of increasing frequencies. For details, refer to the descriptions of channels in the 2.4G band in the related technology.

In some embodiments, in the 2.4G band, center frequencies of the channel 1 to the channel 14 are successively 2412 MHz, 2417 MHz, 2422 MHz, 2427 MHz, 2432 MHZ, 2437 MHz, 2442 MHz, 2447 MHz, 2452 MHz, 2457 MHz, 2462 MHZ, 2467 MHZ, 2472 MHz, and 2484 MHz.

The following exemplarily describes manner 1 with reference to specific examples.

For example, in the foregoing (1), it is assumed that the first frequency is 2442 MHz.

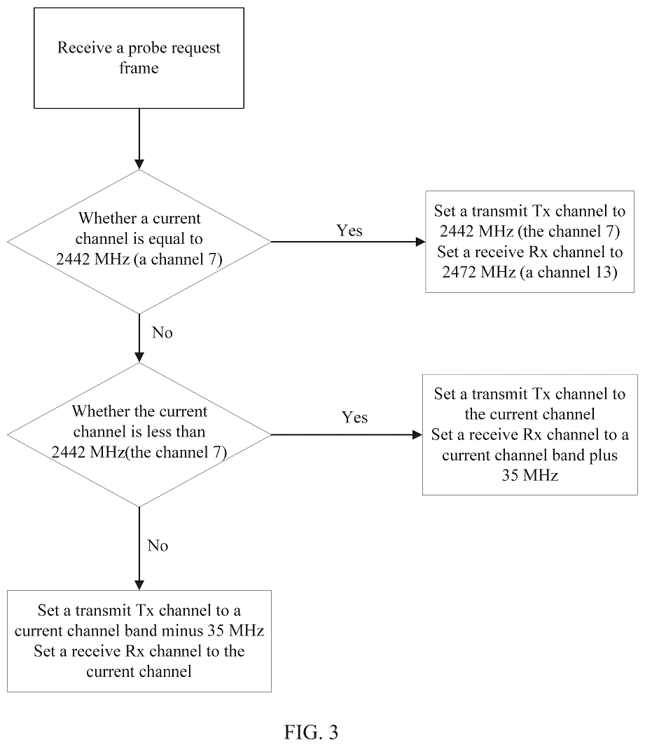

As shown in FIG. 3, after receiving the probe request frame sent by the electronic device, the radio access device may compare the first channel frequency with the first frequency.

In a case that the first channel frequency is 2442 MHz, that is, the first channel is the channel 7 in the 2.4G band, that is, the first channel frequency is equal to the first frequency, the radio access device may set the channel 7 as the target WiFi data transmit channel, and set the channel 13 (that is, the second channel) with the central frequency of 2472 MHz as the target WiFi data receive channel. It can be learned that the target channel allocation policy is the first policy.

In a case that the first channel frequency is 2422 MHz, that is, the first channel is the channel 3, and the first channel frequency is less than 2442 MHz, the radio access device may set the first channel as the target WiFi data transmit channel, and set the channel 10 (that is, the third channel) whose central frequency is equal to the first channel frequency+35 MHz as the target WiFi data receive channel. It can be learned that the target channel allocation policy is the second policy.

In a case that the first channel frequency is 2462 MHZ, that is, the first channel is the channel 11, and the first channel frequency is greater than 2442 MHz, the radio access device may set the first channel as the target WiFi data receive channel, and set the channel 4 (that is, the fourth channel) whose central frequency is equal to the first channel frequency−35 MHz as the target WiFi data transmit channel. It can be learned that the target channel allocation policy is the third policy.

For another example, in the foregoing (2), assuming that the first frequency is 2442 MHz, after receiving the probe request frame sent by the electronic device, the radio access device may compare the first channel frequency with the first frequency.

In a case that the first channel frequency is 2442 MHz, that is, the first channel is the channel 7 in the 2.4G band, that is, the first channel frequency is equal to the first frequency, the radio access device may set the channel 7 as the target WiFi data receive channel, and set the channel 13 (that is, the second channel) with the central frequency of 2472 MHz as the target WiFi data transmit channel. It can be learned that the target channel allocation policy is the first policy.

In a case that the first channel frequency is 2422 MHz, that is, the first channel is the channel 3, and the first channel frequency is less than 2442 MHz, the radio access device may set the first channel as the target WiFi data receive channel, and set the channel 10 (that is, the third channel) whose central frequency is equal to the first channel frequency+35 MHz as the target WiFi data transmit channel. It can be learned that the target channel allocation policy is the second policy.

In a case that the first channel frequency is 2462 MHZ, that is, the first channel is the channel 11, and the first channel frequency is greater than 2442 MHz, the radio access device may set the first channel as the target WiFi data transmit channel, and set the channel 4 (that is, the fourth channel) whose central frequency is equal to the first channel frequency−35 MHz as the target WiFi data receive channel. It can be learned that the target channel allocation policy is the third policy.

In this way, the radio access device may determine different target channel allocation policies based on the first channel frequency and the first frequency corresponding to the target WiFi band, so that different target WiFi data receive channels and target WiFi data transmit channels are configured for the electronic device. Therefore, the electronic device can quickly switch to the target WiFi data receive channel and the target WiFi data transmit channel, thereby improving a WiFi data transmission rate.

Further, the target WiFi data transmit channel and the target WiFi data receive channel may be separately determined from different bands (for example, a first band and a second band) in the target WiFi band. Therefore, channel bands of the target WiFi data transmit channel and the target WiFi data receive channel may be far apart, thereby reducing a requirement on isolation performance of hardware of the electronic device. In some embodiments, in manner 2, the first policy includes: determining a fifth

channel as the target WiFi data transmit channel, and determining a sixth channel as the target WiFi data receive channel, where a channel frequency of the fifth channel is determined based on the first channel frequency of the first channel, a second preset frequency, and a random integer in a first random integer set, and a channel frequency of the sixth channel is determined based on the first channel frequency of the first channel, the second preset frequency, and a random integer in a second random integer set.

In some embodiments, when a channel frequency of the target WiFi data transmit channel is less than a channel frequency of the target WiFi data receive channel, the channel frequency of the fifth channel may be the first channel frequency−the second preset frequency*a random integer in the first random integer set; and the channel frequency of the sixth channel is the first channel frequency+the second preset frequency*a random integer in the second random integer set.

When the channel frequency of the target WiFi data transmit channel is greater than the channel frequency of the target WiFi data receive channel, the channel frequency of the fifth channel may be the first channel frequency+the second preset frequency*a random integer in the first random integer set; and the channel frequency of the sixth channel is the first channel frequency−the second preset frequency*a random integer in the second random integer set.

The second policy includes: determining the first channel as one of the target WiFi data transmit channel and the target WiFi data receive channel, and determining a seventh channel as the other of the target WiFi data transmit channel and the target WiFi data receive channel, where a channel frequency of the seventh channel is determined based on the first channel frequency of the first channel, the second preset frequency, and a random integer in a third random integer set.

In this embodiment of this application, the channel frequency of the seventh channel is the first channel frequency+the second preset frequency*a random integer in the third random integer set.

When the channel frequency of the target WiFi data transmit channel is less than the channel frequency of the target WiFi data receive channel, the second policy is: determining the first channel as the target WiFi data transmit channel, and determining the seventh channel as the target WiFi data receive channel. When the channel frequency of the target WiFi data transmit channel is greater than the channel frequency of the target WiFi data receive channel, the second policy is: determining the first channel as the target WiFi data receive channel, and determining the seventh channel as the target WiFi data transmit channel.

The third policy includes: determining the first channel as one of the target WiFi data transmit channel and the target WiFi data receive channel, and determining an eighth channel as the other of the target WiFi data transmit channel and the target WiFi data receive channel, where a channel frequency of the eighth channel is determined based on the first channel frequency of the first channel, the second preset frequency, and a random integer in a fourth random integer set.

The second preset frequency is a frequency interval between two adjacent channels in the target WiFi band.

In some embodiments, the second preset frequency may be determined by a frequency interval corresponding to the target WiFi band, or may be determined in another manner.

In some embodiments, the second preset frequency may be the same as or different from the first preset frequency. This may be determined based on an actual use requirement. For example, the second preset frequency is the same as the first preset frequency, and the second preset frequency may be 5 MHz.

In this embodiment of this application, the channel frequency of the eighth channel is the first channel frequency−the second preset frequency*a random integer in the fourth random integer set.

When the channel frequency of the target WiFi data transmit channel is less than the channel frequency of the target WiFi data receive channel, the third policy is: determining the first channel as the target WiFi data receive channel, and determining the eighth channel as the target WiFi data transmit channel. When the channel frequency of the target WiFi data transmit channel is greater than the channel frequency of the target WiFi data receive channel, the third policy is: determining the first channel as the target WiFi data transmit channel, and determining the eighth channel as the target WiFi data receive channel.

In some embodiments, assuming that the first channel frequency is 2442 MHZ, the first random integer set may include random integers 1 to 6, the second random integer set may include random integers 1 to 6, the third random integer set may include random integers 1 to 7, and the fourth random integer set may include random integers 1 to 7.

The following describes in detail the WiFi data transmission method provided in this embodiment of this application with reference to specific examples.

For example, in manner 2, an example in which the channel frequency of the target WiFi data transmit channel is less than the channel frequency of the target WiFi data receive channel is used. Assuming that the first channel frequency is 2442 MHz, and the second preset frequency is 5 MHz, the first random integer set may include random integers 1 to 6, the second random integer set may include random integers 1 to 6, the third random integer set may include random integers 1 to 7, and the fourth random integer set may include random integers 1 to 7.

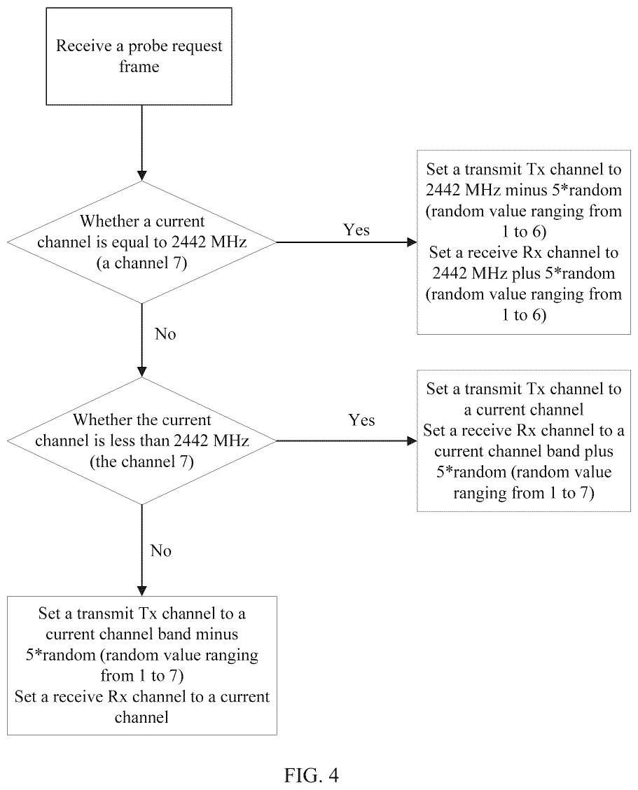

As shown in FIG. 4, after receiving the probe request frame sent by the electronic device, the radio access device may compare the first channel frequency with the first frequency.

In a case that the first channel frequency is 2442 MHz, that is, the first channel is the channel 7 in the 2.4G band, that is, the first channel frequency is equal to the first frequency, the radio access device may determine that the channel frequency of the fifth channel is 2442 MHz−5 (that is, the second preset frequency)*a random integer in the first random integer set (1 to 6). It can be learned that the target WiFi data transmit channel may be any one of the channel 6, the channel 5, the channel 4, the channel 3, the channel 2, or the channel 1. In addition, the radio access device may determine that the channel frequency of the sixth channel is 2442 MHz+5 (that is, the second preset frequency)*a random integer in the second random integer set (1 to 6). It can be learned that the target WiFi data receive channel may be any one of the channel 8, the channel 9, the channel 10, the channel 11, the channel 12, or the channel 13.

In a case that the first channel frequency is 2422 MHz, that is, the first channel is the channel 3, and the first channel frequency is less than 2442 MHz, the radio access device may determine the first channel as the target WiFi data transmit channel, and determine that the channel frequency of the seventh channel is the first channel frequency+5 (that is, the second preset frequency)*a random integer in the third random integer set (that is, 1 to 7). It can be learned that the target WiFi data receive channel is any one of the channel 4, the channel 5, the channel 6, the channel 7, the channel 8, the channel 9, or the channel 10.

In a case that the first channel frequency is 2462 MHZ, that is, the first channel is the channel 11, and the first channel frequency is greater than 2442 MHz, the radio access device may determine that the channel frequency of the eighth channel is the first channel frequency−5 (that is, the second preset frequency)*a random integer in the fourth random integer set (1 to 7). It can be learned that the target WiFi data transmit channel may be any one of the channel 10, the channel 9, the channel 8, the channel 7, the channel 6, the channel 5, or the channel 4.

In this way, in manner 2, the target WiFi data receive channel and the target WiFi data transmit channel may be determined based on the first channel frequency, the second preset frequency, and at least one random integer set, thereby improving flexibility of selecting the target WiFi data receive channel and the target WiFi data transmit channel. It should be noted that, in actual implementation, in a case that the first channel frequency is in the 2.4 band, the target channel allocation policy may be: determining the first channel as the target WiFi data transmit channel, and determining any channel other than the first channel in the 2.4G band as the target WiFi data receive channel; or determining the first channel as the target WiFi data receive channel, and determining any channel other than the first channel in the 2.4G band as the target WiFi data transmit channel. That is, only two different channels in the 2.4G band can be selected.

In some embodiments, the foregoing step 203a may be implemented by the following step D and step E.

Step D: In a case that the first channel frequency of the first channel is within a first band, the radio access device determines the first channel as the target WiFi data transmit channel, and determines any channel within a second band as the target WiFi data receive channel.

Step E: In a case that the first channel frequency of the first channel is within the second band, the radio access device determines the first channel as the target WiFi data receive channel, and determines any channel within the first band as the target WiFi data transmit channel.

The first band and the second band are different bands in a target WiFi band, and the target WiFi band is a band corresponding to the first channel.

In some embodiments, the target WiFi band may be a 5G band or a 6G band.

In some embodiments, when the target WiFi band is a 5G band, the first band may include a band 1 and a band 2 in 5G, and the second band may include a band 3 and a band 4 in 5G; or the first band may include a band 3 and a band 4 in 5G, and the second band may include a band 1 and a band 2 in 5G. The band 1 is 5170 MHz to 5250 MHz, and the band 1 includes a channel 36 to a channel 48; the band 2 is 5250 MHz to 5330 MHZ, and the band 2 includes a channel 52 to a channel 64; the band 3 is 5490 MHz to 5730 MHz, and the band 3 includes a channel 100 to a channel 144; and the band 4 is 5735 MHz to 5835 MHz, and the band 4 includes a channel 149 to a channel 165.

When the target WiFi band is a 6G band, the first band may include a band 1 and a band 2 in 6G, and the second band may include a band 3 and a band 4 in 6G; or the first band may include a band 3 and a band 4 in 6G, and the second band may include a band 1 and a band 2 in 6G. The band 1 is 5945 MHz to 64425 MHz, and the band 1 includes a channel 1 to a channel 93; the band 2 is 6425 MHz to 6525 MHz, and the band 2 includes a channel 97 to a channel 113; the band 3 is 6525 MHz to 6885 MHz, and the band 3 includes a channel 117 to a channel 185; and the band 4 is 6885 MHz to 7125 MHz, and the band 4 includes a channel 189 to a channel 233.

For descriptions of a band and a channel frequency of each channel in the 5G band and the 6G band, refer to the related technology.

In this way, the target WiFi data transmit channel and the target WiFi data receive channel may be separately determined from different bands (for example, the first band and the second band) in the target WiFi band. Therefore, channel bands of the target WiFi data transmit channel and the target WiFi data receive channel may be far apart, thereby reducing a requirement on isolation performance of hardware of the electronic device.

In some embodiments, after the foregoing step 204, the WiFi data transmission method may further include the following step 205 to step 208.

Step 205: The radio access device receives an identity authentication frame on the target WiFi data transmit channel.

The identity authentication frame may be used to request the radio access device to perform identity authentication on the electronic device.

Step 206: The radio access device sends an identity authentication response frame to the electronic device on the target WiFi data receive channel based on the identity authentication frame.

In this embodiment of this application, after receiving the identity authentication frame, the radio access device may perform identity authentication on the electronic device based on the identity authentication frame. If the identity authentication on the electronic device succeeds, the radio access device may send the identity authentication response frame to the electronic device on the target WiFi data receive channel.

In some embodiments, if identity authentication on the electronic device fails, the radio access device may send, to the electronic device on the target WiFi data receive channel, a response frame indicating that the identity authentication fails.

In some embodiments, after the identity authentication on the electronic device succeeds, the radio access device may continue to execute the following step 207.

Step 207: The radio access device receives an association request frame on the target WiFi data transmit channel.

The association request frame may be used to request to be associated with the radio access device.

In this embodiment of this application, that the electronic device requests to be associated with the radio access device may be understood as: the electronic device requests to access a WiFi network of the radio access device.

Step 208: The radio access device sends an association response frame to the electronic device on the target WiFi data receive channel based on the association request frame.

The association response frame may be used to indicate an association result between the electronic device and the radio access device.

In some embodiments, the association result may include: the electronic device is successfully associated with the radio access device, or the electronic device fails to be associated with the radio access device (that is, the electronic device fails to connect to a WiFi network of the radio access device).

In some embodiments, the association request frame may include password information. If the password information is the same as access password information of the radio access device, the radio access device may determine that the electronic device is successfully associated with the radio access device; otherwise, it is determined that the electronic device fails to be associated with the radio access device.

In this way, the radio access device may configure the target WiFi data receive channel and the target WiFi data transmit channel for the electronic device based on a channel frequency of a channel (that is, the first channel) used by the electronic device to send the probe request frame, so that the electronic device can simultaneously receive and send WiFi data, thereby improving a WiFi data transmission rate.

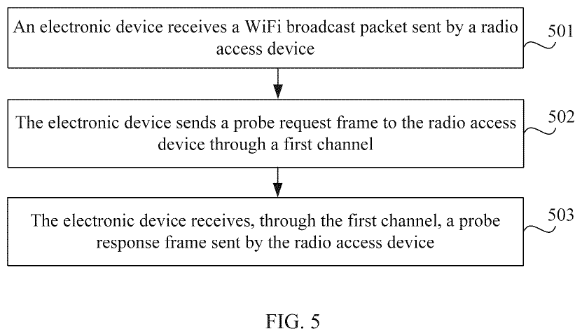

An embodiment of this application provides a WiFi data transmission method. FIG. 5 is a flowchart of a WiFi data transmission method according to an embodiment of this application. The method may be applied to an electronic device. As shown in FIG. 5, the WiFi data transmission method provided in this embodiment of this application may include the following step 501 to step 503.

Step 501: An electronic device receives a WiFi broadcast packet sent by a radio access device.

The WiFi broadcast packet includes channel information of a first channel.

For the WiFi broadcast packet, refer to the descriptions of the related embodiment on the radio access device side.

Step 502: The electronic device sends a probe request frame to the radio access device through the first channel.

The probe request frame is used to indicate that the electronic device supports a simultaneous transmission and reception function.

For the probe request frame, refer to the descriptions of the related embodiment on the radio access device side.

Step 503: The electronic device receives, through the first channel, a probe response frame sent by the radio access device.

The probe response frame is used to instruct the electronic device to perform data transmission with the radio access device through a target WiFi data transmit channel and a target WiFi data receive channel.

In this embodiment of this application, the target WiFi data transmit channel and the target WiFi data receive channel are different channels in a same WiFi band.

In some embodiments, after receiving the probe response frame, the electronic device such as a mobile phone parses information included in the probe response frame to obtain indication information indicating the target WiFi data transmit channel and the target WiFi data receive channel. Then, the electronic device may send WiFi data through the target WiFi data transmit channel and receive WiFi data through the target WiFi data receive channel.

Further, the indication information may further include announcement countdown information. After parsing the announcement information, the electronic device starts channel switching when channel switching needs to be performed, and completes the channel switching before an announcement countdown indicated by the announcement countdown information ends. That is, the electronic device may send WiFi data through the target WiFi data transmit channel and may receive WiFi data through the target WiFi data receive channel before the announcement countdown ends.

In some embodiments, after the foregoing step 503, the WiFi data transmission method provided in this embodiment of this application may further include the following step 504 to step 507.

Step 504: The electronic device sends an identity authentication frame to the radio access device on the target WiFi data transmit channel.

The identity authentication frame may be used to request the radio access device to perform identity authentication on the electronic device.

Step 505: The electronic device receives an identity authentication response frame on the target WiFi data receive channel.

The identity authentication response frame may be used to indicate that the identity authentication on the electronic device succeeds.

In some embodiments, after the identity authentication on the electronic device by the radio access device succeeds, the following step 506 may be executed.

Step 506: The electronic device sends an association request frame to the radio access device on the target WiFi data transmit channel.

The association request frame may be used to request to be associated with the radio access device.

Step 507: The electronic device receives an association response frame on the target WiFi data receive channel.

The association response frame may be used to indicate an association result between the electronic device and the radio access device.

In this embodiment of this application, that the electronic device requests to be associated with the radio access device may be understood as: the electronic device requests to access a WiFi network of the radio access device.

In this way, the electronic device may quickly perform WiFi authentication and association through the target WiFi data transmit channel and the target WiFi data receive channel. Therefore, WiFi can be managed more conveniently and quickly while ensuring network security.

In some embodiments, after the foregoing step 507, the WiFi data transmission method provided in this embodiment of this application may further include the following step 508.

Step 508: In a case that the association response frame indicates that the electronic device is successfully associated with the radio access device, the electronic device sends WiFi data to the radio access device on the target WiFi data transmit channel, and receives, on the target WiFi data transmit channel, WiFi data sent by the radio access device.

It may be understood that the separate target WiFi data transmit channel and target WiFi data receive channel may be used to send and receive data separately, thereby achieving an effect of simultaneously receiving and sending data, thereby improving a WiFi data transmission rate.

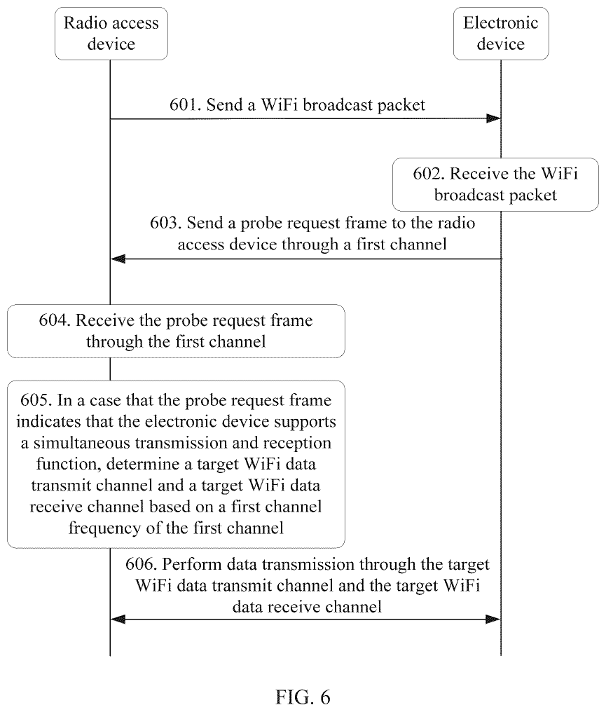

An embodiment of this application provides a WiFi data transmission method. FIG. 6 is a flowchart of a WiFi data transmission method according to an embodiment of this application. As shown in FIG. 6, the WiFi data transmission method provided in this embodiment of this application may include the following step 601 to step 606.

Step 601: A radio access device sends a WiFi broadcast packet.

Step 602: An electronic device receives the WiFi broadcast packet.

Step 603: The electronic device sends a probe request frame to the radio access device through a first channel.

Step 604: The radio access device receives the probe request frame through the first channel.

Step 605: In a case that the probe request frame indicates that the electronic device supports a simultaneous transmission and reception function, the radio access device determines a target WiFi data transmit channel and a target WiFi data receive channel based on a first channel frequency of the first channel.

Step 606: The radio access device and the electronic device perform data transmission through the target WiFi data transmit channel and the target WiFi data receive channel.

In some embodiments, the radio access device performs data transmission with the electronic device through the target WiFi data transmit channel and the target WiFi data receive channel, and the electronic device performs data transmission with the radio access device through the target WiFi data transmit channel and the target WiFi data receive channel. It may be understood that a data transmit channel of the radio access device is a data receive channel of the electronic device.

In the WiFi data transmission method provided in this embodiment of this application, the radio access device may configure the target WiFi data receive channel and the target WiFi data transmit channel for the electronic device based on a channel frequency of a channel (that is, the first channel) used by the electronic device to send the probe request frame, so that the electronic device can simultaneously receive and send WiFi data, thereby improving a WiFi data transmission rate.

In this way, the radio access device can select the target WiFi data transmit channel and the target WiFi data receive channel for the electronic device only when it is determined that the electronic device supports the simultaneous transmission and reception function, thereby saving power consumption of the radio access device.

In some embodiments, after the foregoing step 606, the WiFi data transmission method provided in this embodiment of this application may further include the following step 607 to step 614.

Step 607: The electronic device sends an identity authentication frame to the radio access device on the target WiFi data transmit channel.

Step 608: The radio access device receives the identity authentication frame on the target WiFi data transmit channel.

The identity authentication frame may be used to request the radio access device to perform identity authentication on the electronic device.

Step 609: The radio access device sends an identity authentication response frame to the electronic device on the target WiFi data receive channel based on the identity authentication frame.

In this embodiment of this application, after receiving the identity authentication frame, the radio access device may perform identity authentication on the electronic device based on the identity authentication frame. If the identity authentication on the electronic device succeeds, the radio access device may send the identity authentication response frame to the electronic device on the target WiFi data receive channel.

In some embodiments, if identity authentication on the electronic device fails, the radio access device may send, to the electronic device on the target WiFi data receive channel, a response frame indicating that the identity authentication fails.

Step 610: The electronic device receives the identity authentication response frame on the target WiFi data receive channel.

The identity authentication response frame may be used to indicate that the identity authentication on the electronic device succeeds.

In some embodiments, after the identity authentication on the electronic device by the radio access device succeeds, the following step 611 may be executed.

Step 611: The electronic device sends an association request frame to the radio access device on the target WiFi data transmit channel.

Step 612: The radio access device receives the association request frame on the target WiFi data transmit channel.

The association request frame may be used to request to be associated with the radio access device.

In this embodiment of this application, that the electronic device requests to be associated with the radio access device may be understood as: the electronic device requests to access a WiFi network of the radio access device.

Step 613: The radio access device sends an association response frame to the electronic device on the target WiFi data receive channel based on the association request frame.

Step 614: The electronic device receives the association response frame on the target WiFi data receive channel.

The association response frame may be used to indicate an association result between the electronic device and the radio access device.

In this way, the electronic device may quickly perform WiFi authentication and association through the target WiFi data transmit channel and the target WiFi data receive channel. Therefore, WiFi can be managed more conveniently and quickly while ensuring network security.

In some embodiments, after the foregoing step 614, the WiFi data transmission method may further include the following step 615.

Step 615: In a case that the association response frame indicates that the electronic device is successfully associated with the radio access device, the electronic device sends WiFi data to the radio access device on the target WiFi data transmit channel, and receives, on the target WiFi data transmit channel, WiFi data sent by the radio access device.

It may be understood that the separate target WiFi data transmit channel and target WiFi data receive channel may be used to send and receive data separately, thereby achieving an effect of simultaneously receiving and sending data, thereby improving a WiFi data transmission rate.

In this way, the radio access device may configure the target WiFi data receive channel and the target WiFi data transmit channel for the electronic device based on a channel frequency of a channel (that is, the first channel) used by the electronic device to send the probe request frame, so that the electronic device can simultaneously receive and send WiFi data, thereby improving a WiFi data transmission rate.

For other descriptions of step 601 to step 615, refer to the related descriptions of the foregoing method embodiment on the radio access device side and the foregoing method embodiment on the electronic device side.

The following describes in detail a process in which the electronic device sends WiFi data on the target WiFi data transmit channel and receives WiFi data on the target WiFi data receive channel.

In some embodiments, the electronic device may send the WiFi data to the radio access device on the target WiFi data transmit channel through a first hardware path of the electronic device. The electronic device may receive, on the target WiFi data receive channel through a second hardware path of the electronic device, the WiFi data sent by the radio access device.

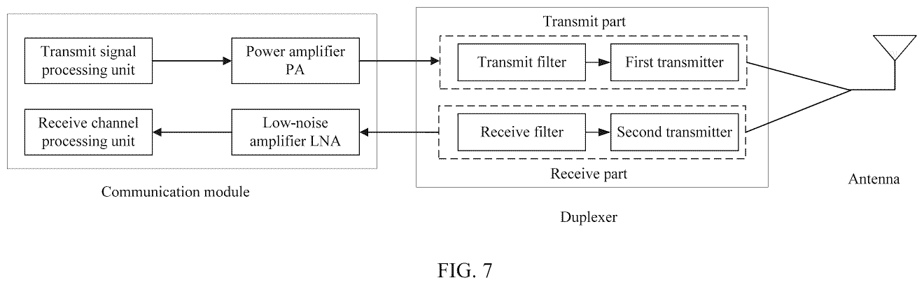

As shown in FIG. 7, the electronic device may include a communication module, a duplexer, and an antenna unit. The duplexer is separately connected to the antenna unit and the communication module.

The communication module includes a transmit signal processing unit, a power amplification unit, a receive channel processing unit, and a low-noise amplifier. The transmit signal processing unit is connected to a first end of the power amplification unit, and the receive channel processing unit is connected to a first end of the low-noise amplifier.

The duplexer includes a transmit filter, a first transmitter, a receive filter, and a second transmitter. A second end of the transmit filter is connected to a first end of the first transmitter, and a second end of the receive filter is connected to a first end of the second transmitter.

A second end of the power amplification unit is connected to a first end of the transmit filter, a second end of the low-noise amplifier is connected to a first end of the receive filter, and both a second end of the first transmitter and a second end of the second transmitter are connected to an antenna.

In some embodiments, the first path includes a transmit signal processing unit, a power amplifier, a transmit filter, a first transmitter, and an antenna, and the second path includes an antenna, a second transmitter, a receive filter, a low-noise amplifier, and a receive signal processing unit.

In this embodiment of this application, a process of sending WiFi data by the electronic device is as follows: The transmit signal processing unit of the communication module inputs a to-be-sent WiFi data packet to the power amplifier, and the power amplifier performs signal amplification on the WiFi data and inputs the amplified WiFi data packet to the transmit filter of the duplexer for filtering; and the filtered WiFi data packet is transmitted to the antenna through the first transmitter, and the antenna sends the filtered WiFi data packet on the target WiFi data transmit channel.

A process of receiving WiFi data by the electronic device is as follows: The antenna receives a WiFi data packet on the target WiFi data receive channel, where the WiFi data packet is input to the receive filter of the duplexer through the second transmitter of the duplexer; and the receive filter filters the WiFi data packet, inputs the filtered WiFi data packet to the low-noise amplifier of the communication module for amplification, and inputs the amplified WiFi data packet to the receive signal processing unit of the communication module.

In some embodiments, the communication module may include a WiFi module.

In this way, the WiFi data received by the electronic device and the WiFi data to be sent by the electronic device may be filtered through the duplexer, so that interference between simultaneously receiving and sending WiFi data can be further reduced, and reliability of simultaneously receiving and sending WiFi data can be improved.

It may be learned that, in this embodiment of this application, in a Wi-Fi broadcast phase, it is declared that transmit Tx and receive Rx separately use different channels, and after a router (the radio access device) returns a probe response, the Tx channel and the Rx channel are separated. Therefore, different Tx channels and Rx channels may be separately used for a subsequent connection process between the electronic device and the router and data transmission after the connection. Meanwhile, signals of Tx data and Rx data are filtered through a duplexer, to increase isolation between the Tx data and the Rx data and improve reliability of simultaneously receiving and sending data.

It should be noted that the WiFi data transmission method provided in the embodiments of this application may be executed by a WiFi data transmission apparatus. In the embodiments of this application, an example in which the WiFi data transmission apparatus executes the WiFi data transmission method is used to describe the WiFi data transmission apparatus provided in the embodiments of this application.

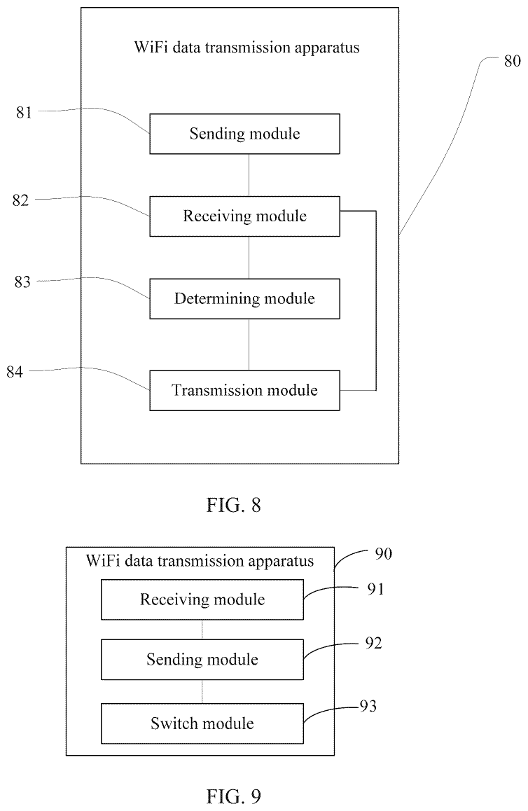

FIG. 8 is a schematic structural diagram of a WiFi data transmission apparatus 80 according to an embodiment of this application. As shown in FIG. 8, the WiFi data transmission apparatus 80 may include a sending module 81, a receiving module 82, a determining module 83, and a transmission module 84.

The sending module 81 is configured to send a WiFi broadcast packet, where the WiFi broadcast packet includes channel information of a first channel. The receiving module 82 is configured to receive, through the first channel, a probe request frame sent by an electronic device. The determining module 83 is configured to: in a case that the probe request frame indicates that the electronic device supports a simultaneous transmission and reception function, determine a target WiFi data transmit channel and a target WiFi data receive channel based on a first channel frequency of the first channel.

The transmission module 84 is configured to perform data transmission through the target WiFi data transmit channel and the target WiFi data receive channel, where the target WiFi data transmit channel and the target WiFi data receive channel are different channels in a same WiFi band.

In an implementation, the determining module 83 is configured to:
determine a target channel allocation policy based on the first channel frequency of the first channel; and
determine the target WiFi data transmit channel and the target WiFi data receive channel based on the target channel allocation policy.

In an implementation, the determining module 83 is configured to:
in a case that the first channel frequency of the first channel is equal to a first frequency, determine that the target channel allocation policy is a first policy; in a case that the first channel frequency of the first channel is less than the first frequency, determine that the target channel allocation policy is a second policy; and in a case that the first channel frequency of the first channel is greater than the first frequency, determine that the target channel allocation policy is a third policy, where the first frequency is a frequency corresponding to a target WiFi band.

In an implementation, the target WiFi band includes a receive channel set and a transmit channel set, and each channel set includes a plurality of channels.

The first policy includes: determining the first channel as the target WiFi data transmit channel, and determining a second channel as the target WiFi data receive channel, where the second channel is an available channel that is in the receive channel set and whose difference from the first channel frequency of the first channel is the largest;
the second policy includes: determining the first channel as the target WiFi data transmit channel, and determining a third channel as the target WiFi data receive channel, where the third channel is a channel that is in the receive channel set and whose difference from the first channel frequency of the first channel is equal to a first preset frequency; and
the third policy includes: determining a fourth channel as the target WiFi data transmit channel, and determining the first channel as the target WiFi data receive channel, where the fourth channel is a channel that is in the transmit channel set and whose difference from the first channel frequency of the first channel is equal to the first preset frequency, where
the first preset frequency is greater than a frequency interval between two adjacent channels in the target WiFi band.

In an implementation, the first policy includes: determining a fifth channel as the target WiFi data transmit channel, and determining a sixth channel as the target WiFi data receive channel, where a channel frequency of the fifth channel is determined based on the first channel frequency of the first channel, a second preset frequency, and a random integer in a first random integer set, and a channel frequency of the sixth channel is determined based on the first channel frequency of the first channel, the second preset frequency, and a random integer in a second random integer set;
the second policy includes: determining the first channel as one of the target WiFi data transmit channel and the target WiFi data receive channel, and determining a seventh channel as the other of the target WiFi data transmit channel and the target WiFi data receive channel, where a channel frequency of the seventh channel is determined based on the first channel frequency of the first channel, the second preset frequency, and a random integer in a third random integer set; and
the third policy includes: determining the first channel as one of the target WiFi data transmit channel and the target WiFi data receive channel, and determining an eighth channel as the other of the target WiFi data transmit channel and the target WiFi data receive channel, where a channel frequency of the eighth channel is determined based on the first channel frequency of the first channel, the second preset frequency, and a random integer in a fourth random integer set.

In an implementation, the determining module 83 is configured to: in a case that the first channel frequency of the first channel is within a first band, determine the first channel as the target WiFi data transmit channel, and determine any channel within a second band as the target WiFi data receive channel; or
the determining module 83 is configured to: in a case that the first channel frequency of the first channel is within the second band, determine the first channel as the target WiFi data receive channel, and determine any channel within the first band as the target WiFi data transmit channel, where
the first band and the second band are different bands in a target WiFi band, and the target WiFi band is a band corresponding to the first channel.

In an implementation, the receiving module 82 is further configured to: after the sending module 84 sends the probe response frame to the electronic device through the first channel, receive, on the target WiFi data transmit channel, an identity authentication frame sent by the electronic device, where the identity authentication frame is used to request the radio access device to perform identity authentication on the electronic device.

The sending module 84 is further configured to send an identity authentication response frame to the electronic device on the target WiFi data receive channel based on the identity authentication frame, where the identity authentication response frame is used to indicate that the identity authentication on the electronic device succeeds.

The receiving module 82 is further configured to receive, on the target WiFi data transmit channel, an association request frame sent by the electronic device, where the association request frame is used to request to be associated with the radio access device.

The sending module 84 is further configured to send an association response frame to the electronic device on the target WiFi data receive channel based on the association request frame, where the association response frame is used to indicate an association result between the electronic device and the radio access device.

In the WiFi data transmission method provided in this embodiment of this application, the target WiFi data receive channel and the target WiFi data transmit channel may be configured for the electronic device based on a channel frequency of a channel (that is, the first channel) used by the electronic device to send the probe request frame, so that the electronic device can simultaneously receive and send WiFi data, thereby improving a WiFi data transmission rate.

FIG. 9 is a schematic structural diagram of a WiFi data transmission apparatus 90 according to an embodiment of this application. As shown in FIG. 9, the WiFi data transmission apparatus 90 may include a receiving module 91, a sending module 92, and a switching module 93.

The receiving module 91 is configured to receive a WiFi broadcast packet sent by a radio access device, where the WiFi broadcast packet includes channel information of a first channel. The sending module 92 is configured to send a probe request frame to the radio access device through the first channel, where the probe request frame is used to indicate that the electronic device supports a simultaneous transmission and reception function. The receiving module 91 is configured to receive, through the first channel, a probe response frame sent by the radio access device, where the probe response frame is used to instruct the electronic device to perform data transmission with the radio access device through a target WiFi data transmit channel and a target WiFi data receive channel, where the target WiFi data transmit channel and the target WiFi data receive channel are different channels in a same WiFi band.

In the WiFi data transmission apparatus provided in this embodiment of this application, after receiving the WiFi data packet broadcast by the radio access device, the WiFi data transmission apparatus may send the probe request frame to the radio access device on the first channel indicated by the WiFi data packet. After receiving the probe request frame, the radio access device configures the target WiFi data receive channel and the target WiFi data transmit channel for the WiFi data transmission apparatus based on a channel frequency of the first channel, so that the WiFi data transmission apparatus can simultaneously receive and send WiFi data, thereby improving a WiFi data transmission rate.

The WiFi data transmission apparatus in this embodiment of this application may be an electronic device, for example, a terminal with an operating system, or may be a component in the electronic device, for example, an integrated circuit or a chip. The electronic device may be a terminal, or another device other than the terminal. For example, the terminal may include but is not limited to the foregoing listed types of the terminal 11, such as a mobile electronic device. The another device may be a server, a network attached storage (Network Attached Storage, NAS), or the like. This is not specifically limited in this embodiment of this application.

The mobile electronic device may be a mobile phone, a tablet computer, a notebook computer, a palmtop computer, a vehicle-mounted electronic device, a mobile Internet device (MID), an augmented reality (AR)/virtual reality (VR) device, a robot, a wearable device, an ultra-mobile personal computer (UMPC), a netbook, a personal digital assistant (PDA), or the like; or may be a server, a network attached storage (NAS), a personal computer (PC), a television (TV), a teller machine, a self-service machine, or the like. This is not specifically limited in this embodiment of this application.

The WiFi data transmission apparatus in this embodiment of this application may be an apparatus with an operating system. The operating system may be an Android operating system, an iOS operating system, or another possible operating system. This is not specifically limited in this embodiment of this application.

The WiFi data transmission apparatus provided in this embodiment of this application can implement the processes implemented in the method embodiments of FIG. 2 to FIG. 6, and achieve a same technical effect. To avoid repetition, details are not described herein again.

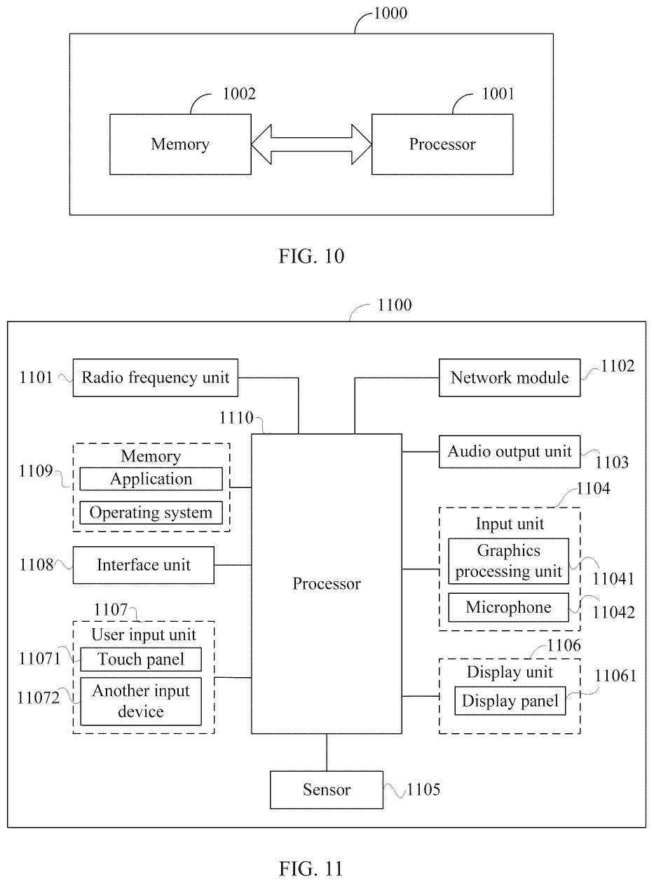

As shown in FIG. 10, an embodiment of this application further provides a communication device 1000, including a processor 1001 and a memory 1002. The memory 1002 stores a program or an instruction that can be run on the processor 1001. For example, when the communication device 1000 is an electronic device, the program or the instruction is executed by the processor 1001 to implement the steps of the foregoing method embodiment on the electronic device side, and a same technical effect can be achieved. When the communication device 1000 is a radio access device, the program or the instruction is executed by the processor 1001 to implement the processes of the foregoing method embodiment on the radio access device side, and a same technical effect can be achieved. To avoid repetition, details are not described herein again.

An embodiment of this application further provides an electronic device, including a processor and a communication interface. The communication interface is configured to receive a WiFi broadcast packet broadcast by a radio access device; send a probe request frame to the radio access device through a first channel; and receive, through the first channel, a probe response frame sent by the radio access device. The processor is configured to switch to a target WiFi data transmit channel and a target WiFi data receive channel based on channel switching announcement information. This electronic device embodiment corresponds to the foregoing method embodiment on the electronic device side. Each implementation process and implementation of the foregoing method embodiment may be applicable to this electronic device embodiment, and a same technical effect can be achieved. FIG. 11 is a schematic structural diagram of hardware of a terminal according to an embodiment of this application.

It should be noted that the electronic device in this embodiment of this application includes the mobile electronic device and the non-mobile electronic device.

FIG. 11 is a schematic structural diagram of hardware of an electronic device according to an embodiment of this application

The terminal 1100 includes but is not limited to components such as a radio frequency unit 1101, a network module 1102, an audio output unit 1103, an input unit 1104, a sensor 1105, a display unit 1106, a user input unit 1107, an interface unit 1108, a memory 1109, and a processor 1110.

A person skilled in the art can understand that the electronic device 1100 may further include the power supply (for example, a battery) that supplies power to each component. The power supply may be logically connected to the processor 110 by using a power supply management system, so as to manage functions such as charging, discharging, and power consumption by using the power supply management system. The structure of the electronic device shown in FIG. 11 does not constitute a limitation on the electronic device, and the electronic device may include more or fewer components than those shown in the figure, or combine some components, or have different component arrangements. Details are not described herein again.

The radio frequency unit 1101 is configured to receive a WiFi broadcast packet sent by a radio access device, where the WiFi broadcast packet includes channel information of a first channel; and send a probe request frame to the radio access device through the first channel.

The radio frequency unit 1101 is further configured to receive, through the first channel, a probe response frame sent by the radio access device, where the probe response frame is used to instruct the electronic device to perform data transmission with the radio access device through a target WiFi data transmit channel and a target WiFi data receive channel, where
the target WiFi data transmit channel and the target WiFi data receive channel are different channels in a same WiFi band.

In the WiFi data transmission method provided in this embodiment of this application, after receiving the WiFi data packet broadcast by the radio access device, the electronic device may send the probe request frame to the radio access device on the first channel indicated by the WiFi data packet. After receiving the probe request frame, the radio access device configures the target WiFi data receive channel and the target WiFi data transmit channel for the electronic device based on a channel frequency of the first channel, so that the electronic device can simultaneously receive and send WiFi data, thereby improving a WiFi data transmission rate.

The electronic device provided in this embodiment of this application can implement the processes implemented in the foregoing method embodiment, and achieve a same technical effect. To avoid repetition, details are not described herein again.

For beneficial effect of the implementations in this embodiment, refer to the beneficial effect of the corresponding implementations in the foregoing method embodiment. To avoid repetition, details are not described herein again.

It should be understood that, in this embodiment of this application, the input unit 1104 may include a Graphics Processing Unit (GPU) 11041 and a microphone 11042, and the graphics processing unit 11041 processes image data of a still image or a video that is obtained by an image capturing apparatus (for example, a camera) in a video capturing mode or an image capturing mode. The display unit 1106 may include a display panel 11061. The display panel 11061 may be configured in a form such as a liquid crystal display or an organic light-emitting diode. The user input unit 1107 includes at least one of a touch panel 11071 or another input device 11072. The touch panel 11071 is also referred to as a touchscreen. The touch panel 11071 may include two parts: a touch detection apparatus and a touch controller. The another input device 11072 may include but is not limited to a physical keyboard, a functional button (such as a volume control button or a power on/off button), a trackball, a mouse, and a joystick. Details are not described herein.

In this embodiment of this application, after receiving downlink data from a network side device (for example, a radio access device), the radio frequency unit 1101 may transmit the downlink data to the processor 1110 for processing. In addition, the radio frequency unit 1101 may send uplink data to the network side device. Usually, the radio frequency unit 1101 includes but is not limited to an antenna, an amplifier, a transceiver, a coupler, a low noise amplifier, a duplexer, and the like.

The memory 1109 may be configured to store a software program or an instruction and various data. The memory 1109 may mainly include a first storage area for storing a program or an instruction and a second storage area for storing data. The first storage area may store an operating system, and an application or an instruction required by at least one function (for example, a sound playing function or an image playing function). In addition, the memory 1109 may be a volatile memory or a non-volatile memory, or the memory 1109 may include a volatile memory and a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1109 in this embodiment of this application includes but is not limited to these memories and a memory of any other proper type.

The processor 1110 may include one or more processing units. In some embodiments, an application processor and a modem processor are integrated into the processor 1110. The application processor mainly processes an operating system, a user interface, an application, and the like. The modem processor mainly processes a wireless communication signal, for example, a baseband processor. It can be understood that the modem processor may not be integrated into the processor 1110.

An embodiment of this application further provides a radio access device, including a processor and a communication interface. The communication interface is configured to broadcast a WiFi broadcast packet, and receive, through a first channel, a probe request frame sent by an electronic device. The processor is configured to determine a target WiFi data transmit channel and a target WiFi data receive channel of the electronic device based on a first channel frequency of the first channel. The communication interface is further configured to send a probe response frame to the electronic device through the first channel. This radio access device embodiment corresponds to the foregoing method embodiment of the radio access device. Each implementation process and implementation of the foregoing method embodiment may be applicable to this radio access device embodiment, and a same technical effect can be achieved.

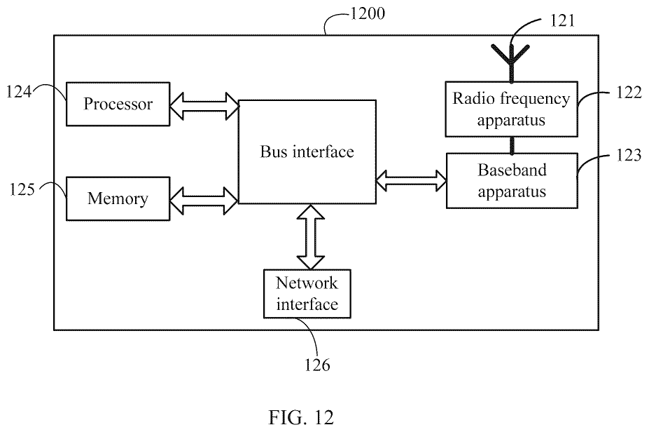

An embodiment of this application further provides a radio access device. As shown in FIG. 12, the radio access device 1200 includes an antenna 121, a radio frequency apparatus 122, a baseband apparatus 123, a processor 124, and a memory 125. The antenna 121 is connected to the radio frequency apparatus 122. In an uplink direction, the radio frequency apparatus 122 receives information by using the antenna 121, and sends the received information to the baseband apparatus 123 for processing. In a downlink direction, the baseband apparatus 123 processes information that needs to be sent, and sends processed information to the radio frequency apparatus 122. The radio frequency apparatus 122 processes the received information, and sends processed information by using the antenna 121.

In the foregoing embodiment, the method executed by the network side device may be implemented in the baseband apparatus 123. The baseband apparatus 123 includes a baseband processor.

The baseband apparatus 123 may include, for example, at least one baseband board, where a plurality of chips are disposed on the baseband board. As shown in FIG. 12, one chip, for example, the baseband processor, is connected to the memory 125 through a bus interface, to invoke a program in the memory 125 to perform the operations of the radio access device shown in the foregoing method embodiment.

The network side device may further include a network interface 126, and the interface is, for example, a common public radio interface (CPRI).

The radio access device 1200 in embodiments of the present application further includes an instruction or a program that is stored in the memory 125 and that can be run on the processor 124. The processor 124 invokes the instruction or the program in the memory 125 to execute the method executed by the modules shown in FIG. 8, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing method embodiment, and a same technical effect can be achieved. To avoid repetition, details are not described herein again.

The processor is a processor in the electronic device in the foregoing embodiment. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application provides a computer program product. The program product is stored in a storage medium. The program product is executed by at least one processor to implement the processes of the foregoing WiFi data transmission method embodiment, and a same technical effect can be achieved. To avoid repetition, details are not described herein again.

An embodiment of this application further provides a communication system, including a radio access device and an electronic device. The radio access device may be configured to execute the steps executed by the electronic device in the foregoing method embodiment on the radio access device side, and the electronic device may be configured to execute the steps executed by the electronic device in the foregoing method embodiment on the electronic device side.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be executed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, a network device, or the like) to execute the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. A method for WiFi data transmission, comprising:
sending, by a radio access device, a WiFi broadcast packet, wherein the WiFi broadcast packet comprises channel information of a first channel;
receiving, by the radio access device through the first channel, a probe request frame sent by an electronic device;
when the probe request frame indicates that the electronic device supports a simultaneous transmission and reception function, determining, by the radio access device, a target WiFi data transmit channel and a target WiFi data receive channel based on a first channel frequency of the first channel; and
performing, by the radio access device, data transmission with the electronic device through the target WiFi data transmit channel and the target WiFi data receive channel, wherein the target WiFi data transmit channel and the target WiFi data receive channel are different channels in a same WiFi band.

2. The method according to claim 1, wherein the determining, by the radio access device, a target WiFi data transmit channel and a target WiFi data receive channel based on a first channel frequency of the first channel comprises:
determining, by the radio access device, a target channel allocation policy based on the first channel frequency of the first channel; and
determining, by the radio access device, the target WiFi data transmit channel and the target WiFi data receive channel based on the target channel allocation policy.

3. The method according to claim 2, wherein the determining, by the radio access device, a target channel allocation policy based on the first channel frequency of the first channel comprises:
when the first channel frequency of the first channel is equal to a first frequency, determining, by the radio access device, that the target channel allocation policy is a first policy;
when the first channel frequency of the first channel is less than the first frequency, determining, by the radio access device, that the target channel allocation policy is a second policy; and
when the first channel frequency of the first channel is greater than the first frequency, determining, by the radio access device, that the target channel allocation policy is a third policy,
wherein the first frequency is a frequency corresponding to a target WiFi band, and the target WiFi band is a band corresponding to the first channel.

4. The method according to claim 3, wherein the target WiFi band comprises a receive channel set and a transmit channel set, and each channel set comprises a plurality of channels;
the first policy comprises: determining the first channel as the target WiFi data transmit channel, and determining a second channel as the target WiFi data receive channel, wherein the second channel is an available channel that is in the receive channel set and whose difference from the first channel frequency of the first channel is the largest;
the second policy comprises: determining the first channel as the target WiFi data transmit channel, and determining a third channel as the target WiFi data receive channel, wherein the third channel is a channel that is in the receive channel set and whose difference from the first channel frequency of the first channel is equal to a first preset frequency; and
the third policy comprises: determining a fourth channel as the target WiFi data transmit channel, and determining the first channel as the target WiFi data receive channel, wherein the fourth channel is a channel that is in the transmit channel set and whose difference from the first channel frequency of the first channel is equal to the first preset frequency,
wherein the first preset frequency is greater than a frequency interval between two adjacent channels in the target WiFi band.

5. The method according to claim 3, wherein:
the first policy comprises: determining a fifth channel as the target WiFi data transmit channel, and determining a sixth channel as the target WiFi data receive channel, wherein a channel frequency of the fifth channel is determined based on the first channel frequency of the first channel, a second preset frequency, and a random integer in a first random integer set, and a channel frequency of the sixth channel is determined based on the first channel frequency of the first channel, the second preset frequency, and a random integer in a second random integer set;
the second policy comprises: determining the first channel as one of the target WiFi data transmit channel and the target WiFi data receive channel, and determining a seventh channel as the other of the target WiFi data transmit channel and the target WiFi data receive channel, wherein a channel frequency of the seventh channel is determined based on the first channel frequency of the first channel, the second preset frequency, and a random integer in a third random integer set; and
the third policy comprises: determining the first channel as one of the target WiFi data transmit channel and the target WiFi data receive channel, and determining an eighth channel as the other of the target WiFi data transmit channel and the target WiFi data receive channel, wherein a channel frequency of the eighth channel is determined based on the first channel frequency of the first channel, the second preset frequency, and a random integer in a fourth random integer set.

6. The method according to claim 2, wherein the determining, by the radio access device, a target channel allocation policy based on the first channel frequency of the first channel comprises:
when the first channel frequency of the first channel is within a first band, determining, by the radio access device, the first channel as the target WiFi data transmit channel, and determining any channel within a second band as the target WiFi data receive channel; and
when the first channel frequency of the first channel is within the second band, determining, by the radio access device, the first channel as the target WiFi data receive channel, and determining any channel within the first band as the target WiFi data transmit channel,
wherein the first band and the second band are different bands in a target WiFi band, and the target WiFi band is a band corresponding to the first channel.

7. A method for WiFi data transmission, comprising:
receiving, by an electronic device, a WiFi broadcast packet sent by a radio access device, wherein the WiFi broadcast packet comprises channel information of a first channel;
sending, by the electronic device, a probe request frame to the radio access device through the first channel, wherein the probe request frame is used to indicate that the electronic device supports a simultaneous transmission and reception function; and
receiving, by the electronic device through the first channel, a probe response frame sent by the radio access device, wherein the probe response frame is used to instruct the electronic device to perform data transmission with the radio access device through a target WiFi data transmit channel and a target WiFi data receive channel,
wherein the target WiFi data transmit channel and the target WiFi data receive channel are different channels in a same WiFi band.

8. A radio access device, comprising a processor and a memory storing a program or an instruction that is capable of running on the processor, wherein the program or the instruction, when executed by the processor, causes the radio access device to perform:
sending a WiFi broadcast packet, wherein the WiFi broadcast packet comprises channel information of a first channel;
receiving, through the first channel, a probe request frame sent by an electronic device;
when the probe request frame indicates that the electronic device supports a simultaneous transmission and reception function, determining a target WiFi data transmit channel and a target WiFi data receive channel based on a first channel frequency of the first channel; and
performing data transmission with the electronic device through the target WiFi data transmit channel and the target WiFi data receive channel, wherein the target WiFi data transmit channel and the target WiFi data receive channel are different channels in a same WiFi band.

9. The radio access device according to claim 8, wherein the determining a target WiFi data transmit channel and a target WiFi data receive channel based on a first channel frequency of the first channel comprises:
determining a target channel allocation policy based on the first channel frequency of the first channel; and
determining the target WiFi data transmit channel and the target WiFi data receive channel based on the target channel allocation policy.

10. The radio access device according to claim 9, wherein the determining a target channel allocation policy based on the first channel frequency of the first channel comprises:
when the first channel frequency of the first channel is equal to a first frequency, determining that the target channel allocation policy is a first policy;
when the first channel frequency of the first channel is less than the first frequency, determining that the target channel allocation policy is a second policy; and
when the first channel frequency of the first channel is greater than the first frequency, determining that the target channel allocation policy is a third policy,
wherein the first frequency is a frequency corresponding to a target WiFi band, and the target WiFi band is a band corresponding to the first channel.

11. The radio access device according to claim 10, wherein the target WiFi band comprises a receive channel set and a transmit channel set, and each channel set comprises a plurality of channels;
the first policy comprises: determining the first channel as the target WiFi data transmit channel, and determining a second channel as the target WiFi data receive channel, wherein the second channel is an available channel that is in the receive channel set and whose difference from the first channel frequency of the first channel is the largest;
the second policy comprises: determining the first channel as the target WiFi data transmit channel, and determining a third channel as the target WiFi data receive channel, wherein the third channel is a channel that is in the receive channel set and whose difference from the first channel frequency of the first channel is equal to a first preset frequency; and
the third policy comprises: determining a fourth channel as the target WiFi data transmit channel, and determining the first channel as the target WiFi data receive channel, wherein the fourth channel is a channel that is in the transmit channel set and whose difference from the first channel frequency of the first channel is equal to the first preset frequency,
wherein the first preset frequency is greater than a frequency interval between two adjacent channels in the target WiFi band.

12. The radio access device according to claim 10, wherein:
the first policy comprises: determining a fifth channel as the target WiFi data transmit channel, and determining a sixth channel as the target WiFi data receive channel, wherein a channel frequency of the fifth channel is determined based on the first channel frequency of the first channel, a second preset frequency, and a random integer in a first random integer set, and a channel frequency of the sixth channel is determined based on the first channel frequency of the first channel, the second preset frequency, and a random integer in a second random integer set;
the second policy comprises: determining the first channel as one of the target WiFi data transmit channel and the target WiFi data receive channel, and determining a seventh channel as the other of the target WiFi data transmit channel and the target WiFi data receive channel, wherein a channel frequency of the seventh channel is determined based on the first channel frequency of the first channel, the second preset frequency, and a random integer in a third random integer set; and
the third policy comprises: determining the first channel as one of the target WiFi data transmit channel and the target WiFi data receive channel, and determining an eighth channel as the other of the target WiFi data transmit channel and the target WiFi data receive channel, wherein a channel frequency of the eighth channel is determined based on the first channel frequency of the first channel, the second preset frequency, and a random integer in a fourth random integer set.

13. The radio access device according to claim 9, wherein the determining a target channel allocation policy based on the first channel frequency of the first channel comprises:
when the first channel frequency of the first channel is within a first band, determining the first channel as the target WiFi data transmit channel, and determining any channel within a second band as the target WiFi data receive channel; and
when the first channel frequency of the first channel is within the second band, determining the first channel as the target WiFi data receive channel, and determining any channel within the first band as the target WiFi data transmit channel,
wherein the first band and the second band are different bands in a target WiFi band, and the target WiFi band is a band corresponding to the first channel.

14. An electronic device, comprising a processor and a memory storing a program or an instruction that is capable of running on the processor, wherein the program or the instruction, when executed by the processor, causes the electronic device to perform the method according to claim 7.

15. A non-transitory computer-readable storage medium storing a program or an instruction, wherein the program or the instruction, when executed by a processor, causes the processor to implement the method according to claim 1.
